(19) United States
(12) Patent Application Publication
(10) Pub. No.: US 2008/0310892 A1
(43) Pub. Date: Dec. 18, 2008

(54) IMAGE-FORMING APPARATUS

(75) Inventors: Yasuyuki Inada, Tokyo (JP); Tomohide Mori, Tokyo (JP); Toshiaki Hiroi, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 12/125,136

(22) Filed: May 22, 2008

(30) Foreign Application Priority Data
Jun. 15, 2007 (JP) 2007-158455

(51) Int. Cl. G03G 15/16

(52) U.S. Cl. 399/308

(57) ABSTRACT

An image-forming apparatus comprises,
a latent-image supporting member, and
an intermediate transfer member having a hard releasing layer formed on the surface of the intermediate transfer member that supports a toner image primarily transferred thereon from the latent-image supporting member, and secondarily transfers the supported toner image onto an image receiving medium,
wherein a pressing force F, exerted at a contact portion between the intermediate transfer member and the latent-image supporting member, is set to 4.4 N/m or less.

This application is based on application(s) No. 2007-158455 filed in Japan, the contents of which are hereby incorporated by reference.

### BACKGROUND OF THE INVENTION

1. Field of the Invention

The present invention relates to an image-forming apparatus, such as a mono-chrome/full-color copying machine, a printer, a facsimile and a composite machine of these.

2. Description of the Related Art

In an image-forming apparatus of an intermediate transfer system in which toner images of respective colors, formed on latent-image supporting members, are respectively primary-transferred, and superposed on an intermediate transfer member, and then secondary-transferred onto an image receiving medium at one time, such an image-forming apparatus which uses an intermediate transfer member having a hard releasing layer formed on the surface thereof so as to improve the releasing property to the toner, has been proposed in order to improve the secondary transferring rate. With this arrangement, it becomes possible not only to improve the image quality, but also to reduce residual toner after the secondary-transferring process (waste toner) remaining on the intermediate transfer member after the secondary-transferring process; thus, it becomes possible to reduce the amount of waste toner to be discharged, and consequently to reduce the environmental load as well as loads imposed on the user, such as exchanging operations of waste-toner recovery containers.

In the above-mentioned image-forming apparatus, however, upon primary-transferring a toner image formed on the latent-image supporting member onto the intermediate transfer member, the toner image is sandwiched between the latent-image supporting member and the intermediate transfer member to be aggregated under a pressing force to cause a problem of occurrence of a void. More specifically, as shown in FIG. 20, one portion 101 of the aggregated toner comes to have an increased adhesive strength to a latent-image supporting member 103 rather than to an intermediate transfer member 102 having a higher releasing property, and is not primary-transferred to remain on the latent-image supporting member 103. In particular, in the center portion of a character image and a fine line image where a pressing force becomes higher to increase the toner aggregating force, the occurrence of a void becomes conspicuous.

A technique has been proposed in which in a primary transferring unit, a transfer roller is fixedly placed so as to provide a gap between the latent-image supporting member and the transfer belt even during an image-forming process so that reverse transfer is prevented (JP-A No. 2003-156947, JP-A No. 2005-134735).

### BRIEF SUMMARY OF THE INVENTION

An object of the present invention is to provide an image-forming apparatus which can restrain the occurrence of a void, and also improve a secondary transferring rate.

The above object can be achieved by an image-forming apparatus, which is provided with an intermediate transfer member that supports a toner image primarily transferred thereon from a latent-image supporting member, and secondarily transfers the supported toner image onto an image receiving medium, comprising:

a hard releasing layer formed on the surface of the intermediate transfer member,

wherein a pressing force F, exerted at a contact portion between the intermediate transfer member and the latent-image supporting member, is set to 4.4 N/m or less.

### BRIEF DESCRIPTION OF THE DRAWINGS

FIG. 1 is a schematic block diagram that shows one example of an image-forming apparatus in accordance with the present invention.

FIG. 2 is a schematic cross-sectional view that shows a layer structure of an intermediate transfer member.

FIG. 3 is an explanatory view for a manufacturing apparatus used for manufacturing the intermediate transfer member.

FIG. 4 is an enlarged view that shows a primary transfer unit in one example of an embodiment of the present invention.

FIG. 5 is a schematic sketch view that shows the primary transfer unit in one example of an embodiment of the present invention.

FIG. 6 is a schematic cross-sectional view that shows a measuring jig member used for measuring a pressing force F.

FIG. 7 is a schematic sketch view that shows the measuring jig member used for measuring the pressing force F.

FIG. 8 is a graph that shows the relationship between a pitch ring diameter and the pressing force F in Experimental Example 1.

FIG. 9 is a graph that shows the relationship between the pitch ring diameter and a void rank in Experimental Example 1.

FIG. 10 is a graph that shows the relationship between the pressing force F and the void rank in Experimental Example 1.

FIG. 11 is a graph that shows the relationship between the pitch ring diameter and a contact width W in Experimental Example 1.

FIG. 12 is a graph that shows the relationship between the contact width W and the pressing force F in Experimental Example 1.

FIG. 13 is a graph that shows the relationship between the contact width W and the void rank in Experimental Example 1.

FIG. 14 is a graph that shows the relationship between a pitch ring diameter and the pressing force F in Experimental Example 2.

FIG. 15 is a graph that shows the relationship between the pitch ring diameter and a void rank in Experimental Example 2.

FIG. 16 is a graph that shows the relationship between the pressing force F and the void rank in Experimental Example 2.

FIG. 17 is a graph that shows the relationship between the pitch ring diameter and a contact width W in Experimental Example 2.

FIG. 18 is a graph that shows the relationship between the contact width W and the pressing force F in Experimental Example 2.

FIG. 19 is a graph that shows the relationship between the contact width W and the void rank in Experimental Example 2.

FIG. 20 is a conceptual view that explains a mechanism in which a void occurs due to toner aggregation.

### DETAILED DESCRIPTION OF THE INVENTION

The present invention relates to an image-forming apparatus, which is provided with an intermediate transfer member that supports a toner image primary-transferred thereon from a latent-image supporting member, and secondary-transfers the supported toner image onto an image receiving medium, and in this structure, the intermediate transfer member has a hard releasing layer formed on the surface thereof, and a contact portion between the intermediate transfer member and the latent-image supporting member is allowed to exert a pressing force F of 4.4 N/m or less.

In accordance with the image-forming apparatus of the present invention, even when an intermediate transfer member on the surface of which a hard releasing layer having a high releasing property is formed in order to improve a secondary transferring rate and image quality is used, a pressing force to be applied to a toner image in a primary transferring unit is reduced so that toner aggregation is suppressed; therefore, it becomes possible to improve a void-preventive property of a printed image.

An image-forming apparatus according to the present invention is provided with an intermediate transfer member that supports a toner image primary-transferred from a latent-image supporting member, and secondary-transfers the supported toner image onto an image receiving medium. The following description will discuss the image-forming apparatus of the present invention by exemplifying a tandem-type full-color image-forming apparatus having latent-image supporting members for respective developing units of respective colors, each of which forms a toner image on the latent-image supporting member; however, any apparatus having any structure may be used as long as it has a specific intermediate transfer member, with a predetermined pressing force F being achieved, and, for example, a four-cycle full-color image-forming apparatus, which has developing units of respective colors for a single latent-image supporting member, may be used.

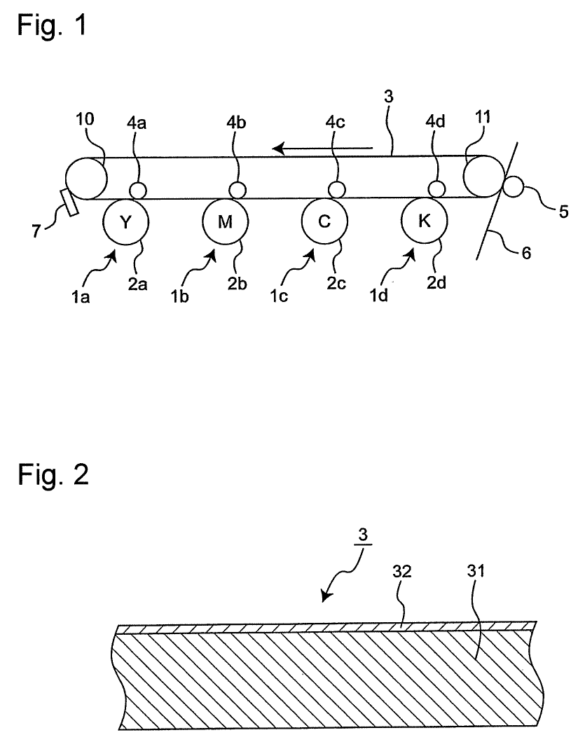

FIG. 1 is a schematic block diagram that shows one example of an image-forming apparatus of the present invention. In a tandem-type full-color image-forming apparatus of FIG. 1, each of developing units (1a, 1b, 1c and 1d) is normally provided with at least a charging device, an exposing device, a developing device, a cleaning device and the like (none of which are shown) that are placed around each of latent-image supporting members (2a, 2b, 2c and 2d). These developing units (1a, 1b, 1c and 1d) are placed in parallel with an intermediate transfer member 3 that is extended by extension rollers (10 and 11) so as to be passed over them. Toner images, formed on the surfaces of the latent-image supporting members (2a, 2b, 2c and 2d) in the respective developing units, are respectively primary-transferred on the intermediate transfer member 3 by using primary transfer rollers (4a, 4b, 4c and 4d), and superposed on the intermediate transfer member so that a full-color image is formed. The full-color image, transferred onto the surface of the intermediate transfer member 3, is secondary-transferred onto an image receiving medium 6 such as paper at one time by using a secondary transfer roller 5, and then allowed to pass through a fixing device (not shown) so that a full-color image is formed on the image receiving medium. Here, residual toner after the transferring process, left on the intermediate transfer member, is removed by a belt cleaning device 7.

The latent-image supporting members (2a, 2b, 2c and 2d) are so-called photosensitive members on which toner images are formed based upon electrostatic latent images formed on the surfaces thereof. With respect to the latent-image supporting member, not particularly limited as long as it can be installed in a conventional image-forming apparatus, such a member having an organic-based photosensitive layer is normally used.

In the present invention, the intermediate transfer member 3 has a hard releasing layer on its surface. In FIG. 1, an intermediate transfer belt is shown as the intermediate transfer member 3; however, not limited to this, as long as the hard releasing layer is placed on the surface, for example, a so-called intermediate transfer drum may be used.

By exemplifying the intermediate transfer member 3 having a seamless belt shape, the following description will discuss the intermediate transfer member of the present invention. FIG. 2 is a schematic cross-sectional view that shows a layer structure of the intermediate transfer belt 3.

The intermediate transfer belt 3 has at least a substrate 31 and a hard releasing layer 32 formed on the surface of the substrate 31.

Although not particularly limited, the substrate 31 is a seamless belt having a volume resistivity in the range from 1×10⁶ Ω·cm to 1×10¹² Ω·cm and a surface resistivity in the range from 1×10⁷ Ω/square to 1×10¹²/square and is made from a material formed by dispersing a conductive filler such as carbon in the following materials or by adding an ionic conductive material to the following materials: resin materials, such as polycarbonate (PC); polyimide (PI); polyphenylene sulfide (PPS); polyamideimide (PAI); fluorine-based resins like polyvinylidene fluoride (PVDF); a tetrafluoroethylene-ethylene copolymer (ETFE); urethane-based resins like polyurethane; and polyamide-based resins like nylons, or rubber materials such as ethylene-propylene-diene rubber (EPDM); nitrile-butadiene rubber (NBR); chloroprene rubber (CR); silicone rubber; and urethane rubber. In the case of a resin material, the thickness of the substrate is normally set to 50 to 200 μm, and in the case of a rubber material, it is set to 300 to 700 μm.

The intermediate transfer belt 3 may have another layer between the substrate 31 and the hard releasing layer 32, and the hard releasing layer 32 is placed as the outermost surface layer.

Prior to the lamination process of the hard releasing layer 32, the surface of the substrate 31 may be pre-treated by a known surface treating method, such as plasma, flame and UV ray irradiation.

The hard releasing layer 32, which is an inorganic layer made from an inorganic material, is so hard that it exerts a releasing property against toner. Specific examples of the hard releasing layer 32 include an inorganic oxide layer and a hard carbon-containing layer. The hardness of the hard releasing layer 32 is normally set to 3 GPa or more, in particular, to 3 to 11 GPa.

In the present specification, the hardness of the hard releasing layer is measured by a nano-indentation method, and given as a value obtained by using a NANO Indenter XP/DCM (MTS Systems Corporation./MTS NANO Instruments).

The inorganic oxide layer, which has a thickness in the range from 10 to 100 nm, is preferably made from a material containing at least one oxide selected from SiO₂, Al₂O₃, ZrO₂ , TiO₂, and in particular, SiO₂ is more preferably contained. The inorganic oxide layer is preferably formed by using a plasma CVD method in which a mixed gas containing at least a discharge gas and a material gas for the inorganic oxide layer is formed into a plasma so that a film is deposited and formed in accordance with the material gas, in particular, by using such a plasma CVD method carried out under atmospheric pressure or under near atmospheric pressure.

By exemplifying a process in which an inorganic oxide layer using silicon oxide (SiO₂) is formed through an atmospheric pressure plasma CVD method, the following description will discuss the manufacturing apparatus and the manufacturing method thereof. The atmospheric pressure or pressure near the atmospheric pressure refers to a pressure in the range from 20 kPa to 110 kPa, and the pressure is more preferably set in the range from 93 kPa to 104 kPa in order to obtain desirable effects described in the present invention.

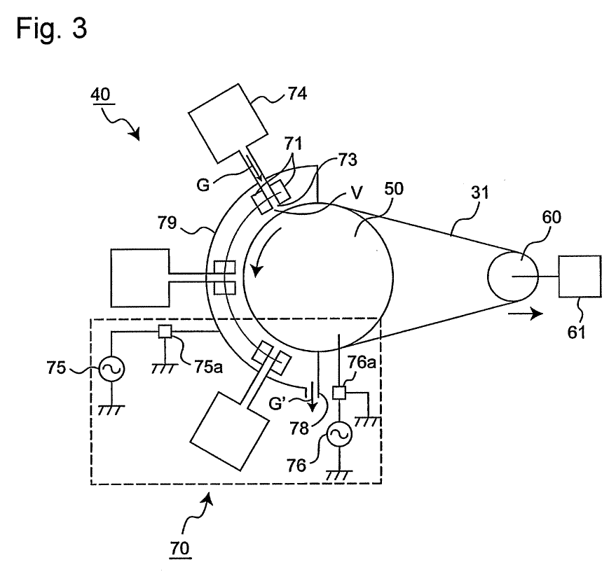

FIG. 3 is an explanatory view that shows a manufacturing apparatus used for manufacturing the inorganic oxide layer. A manufacturing apparatus 40 of the inorganic oxide layer has a structure in which the discharging space and the thin-film depositing area are prepared as virtually the same portion, and by using a direct system in which the substrate is exposed to plasma so as to carry out depositing and forming processes, the inorganic oxide layer is formed on the substrate, and is configured by a roll electrode 50 that rotates in an arrow direction with the substrate 31 shaped into an endless belt being passed thereon, a driven roller 60 and an atmospheric pressure plasma CVD device 70 that is a film-forming device used for forming the inorganic oxide layer on the surface of the substrate.

The atmospheric pressure plasma CVD device 70 is provided with at least one set of a fixed electrode 71, a discharging space 73 that forms an opposing area between the fixed electrode 71 and a roll electrode 50, and allows a discharging to be exerted therein, a mixed gas supplying device 74 that generates a mixed gas G of at least material gas and a discharge gas, and supplies the mixed gas G to the discharging space 73, a discharging container 79 that reduces an air flow entering the discharging space 73 or the like, a first power supply 75 connected to the fixed electrode 71, a second power supply 76 connected to the roll electrode 50 and an exhausting unit 78 used for exhausting the used exhaust gas G′, which are placed along the periphery of the roll electrode 50. The second power supply 76 may be connected to the fixed electrode 71, and the first power supply 75 may be connected to the roll electrode 50.

The mixed gas supplying device 74 supplies a mixed gas containing a material gas used for forming a film containing silicon oxide, and a rare gas, such as a nitrogen gas or an argon gas, to the discharging space 73.

The driven roller 60 is pressed in an arrow direction by a tension applying means 61 so that a predetermined tension is imposed on the substrate 31. The tension applying means 61 releases the application of the tension upon exchanging the substrate 31 or the like so that the exchanging process of the substrate 31 can be carried out easily.

The first power supply 75 outputs a voltage having a frequency ω1, and the second power supply 76 outputs a voltage having a frequency ω2 higher than the frequency ω1 so that an electric field V in which the frequencies ω1 and ω2 are multiplexed is generated in a discharging space 73 by these voltages. Thus, a mixed gas G is formed into plasma by the electric field V so that a film (inorganic oxide layer) is deposited on the surface of the substrate 31 in accordance with a material gas contained in the mixed gas G.

Another embodiment in which, of the roll electrode 50 and the fixed electrode 71, one of the electrodes is connected to the earth, with the other electrode being connected to the power supply, may be used. In this case, the second power supply is preferably used as the corresponding power supply because a precise film-forming process is available, and this method is preferably used, in particular, in the case when a rare gas such as argon gas is used as the discharge gas.

Among a plurality of fixed electrodes, those fixed electrodes positioned on the downstream side in the rotation direction of the roll electrode and a mixed gas supplying device may be used to deposit the inorganic oxide layers in a manner so as to be stacked so that the thickness of the inorganic oxide layers is adjusted.

Among a plurality of fixed electrodes, the fixed electrode positioned on the farthest downstream side in the rotation direction of the roll electrode and a mixed gas supplying device may be used to deposit the inorganic oxide layers, and the other fixed electrodes positioned on the upper stream side and the mixed gas supplying device may be used to deposit another layer, such as an adhesive layer used for improving the adhesive property between the inorganic oxide layer and the substrate.

In order to improve the adhesive property between the inorganic oxide layer and the substrate, a gas-supplying device for supplying a gas such as an argon, oxygen or hydrogen gas and a fixed electrode are placed on the upstream side of the fixed electrode and the mixed gas supplying device used for forming the inorganic oxide layer, so as to carry out a plasma process so that the surface of the substrate may be activated.

Specific examples of the hard-carbon containing layer serving as the hard releasing layer 32 include an amorphous carbon film, a hydrogenated amorphous carbon film, a tetrahedron amorphous carbon film, a nitrogen-containing amorphous carbon film, a metal containing amorphous carbon film, and the like. The thickness of the hard carbon containing layer is preferably set to the same thickness as that of the inorganic oxide layer.

The hard carbon containing layer may be manufactured by using the same method as the above-mentioned manufacturing method of the inorganic oxide layer; that is, it is manufactured by using a plasma CVD method in which at least a mixed gas of a discharge gas and a material gas is formed into a plasma so that a film is deposited and formed in accordance with the material gas, in particular, by using the plasma CVD method carried out under atmospheric pressure or under near atmospheric pressure.

With respect to the material gas to be used for forming the hard carbon containing layer, an organic compound gas, which is in a gaseous state or in a liquid state under normal pressure, in particular, a hydrogen carbide gas, is preferably used. The phase state of each of these materials is not necessarily set to a gaseous phase under normal temperature and normal pressure, and those having either a liquid phase or a solid phase may be used as long as they can be evaporated through fusion, evaporation or sublimation, by a heating process, a pressure-reducing process or the like carried out in the mixed gas supplying device. With respect to the hydrogen carbide gas serving as the material gas, a gas containing at least hydrogen carbide, such as paraffin-based hydrogen carbide such as CH₄, C₂H₆, C₃H₈ and C₄H₁₀, acetylene-based hydrogen carbide such as C₂H₂ and C₂H₄, olefin-based hydrogen carbide, diolefin-based hydrogen carbide, and aromatic hydrogen carbide, may be used. Except for hydrogen carbide, for example, any compound may be used as long as it contains at least carbon elements, such as alcohols, ketones, ethers, esters, CO and CO₂.

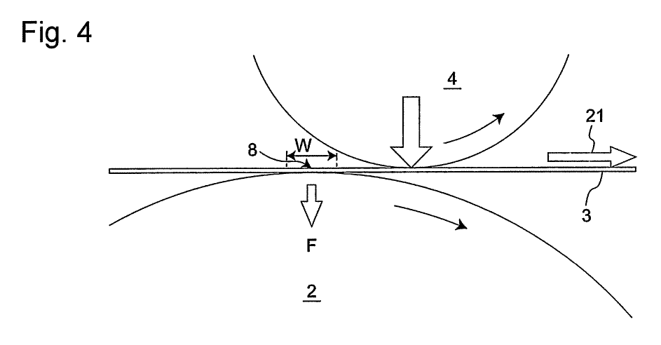

The intermediate transfer member 3 of this kind is passed over the latent-image supporting member 2, and as shown in FIG. 4, a nip section (contact portion) 8 along which the latent-image supporting member 2 and the intermediate transfer member 3 are continuously made in contact with each other is formed. As a result, since the intermediate transfer member 3 is allowed to press the latent-image supporting member 2 so that, for example, when a predetermined voltage is applied to a primary transfer roller, which will be described later, it is allowed to support a toner image on the latent-image supporting member on its surface. FIG. 4 is an enlarged view showing the contact portion (nip section) between the intermediate transfer member 3 and the latent-image supporting member 2 (2a, 2b, 2c and 2d) in FIG. 1.

In the contact portion 8, a force F to be applied to the latent-image supporting member 2 by the intermediate transfer member 3 is set to 4.4 N/m or less, in particular, in the range from 0.05 to 4.4 N/m, preferably from 0.05 to 2.0 N/m. When the pressing force F exceeds 4.4 N/m, toner aggregation becomes conspicuous, to cause occurrence of a void. The pressing force F is also referred to as a nip pressure.

The pressing force F can be measured by using a load converter which converts a load into a voltage value. Here, a strain gauge type load converter 9E01-L43-10N (made by NEC San-ei Instruments, Ltd.) is listed as one example of the load converter. More specifically, as shown in FIG. 6, a load converter 80 and a pressing unit 81 are assembled into a cylindrical member 82 as a measuring jig member 83 so that a dummy photosensitive member for use in measuring is manufactured. At this time, the peripheral curved face of the pressing unit 81 has the same curvature radius as that of the peripheral surface of the latent-image supporting member to be measured. FIG. 6 is a cross-sectional view perpendicular to the axis of the cylindrical member with respect to the measuring jig member 83, and FIG. 7 is a schematic sketch view that shows the measuring jig member of FIG. 6 viewed from a lateral direction. The measuring jig member 83 is assembled in place of the latent-image supporting member at the contact portion between the intermediate transfer member to be measured and the latent-image supporting member so that a load at the contact portion is measured. Based upon the load at the contact portion and the distance between the intermediate transfer member and the pressing portion of the measuring jig member in the axis direction of the cylindrical member at the contact portion, the pressing force F is calculated based upon the following equation.

Pressing force F=Load at contact portion/Distance in axis direction of cylindrical member

The contact width (nip width) W of the contact portion 8 in the moving direction of the intermediate transfer member is not particularly limited as long as the pressing force F is maintained within the above-mentioned range, but is normally set to 2.2 mm or less, in particular, in the range from 0.01 to 2.2 mm.

For example, when the substrate of the intermediate transfer member is prepared as a non-elastic substrate made from a material whose shape is hardly returned to its original shape even upon removal of an applied external force, such as polycarbonate (PC), polyimide (PI), polyphenylene sulfide (PPS), polyamideimide (PAI), fluorine-based resins like polyvinylidene fluoride (PVDF) and a tetrafluoroethylene-ethylene copolymer (ETFE), an urethane-based resins like polyurethane, and polyamide-based resins like nylons, the contact width W is normally set to 0.5 mm or less, in particular, in the range from 0.01 to 0.5 mm.

For example, when the substrate of the intermediate transfer member is prepared as an elastic substrate made from a material whose shape is comparatively easily returned to its original shape upon removal of an applied external force, such as ethylene-propylene-diene rubber (EPDM), nitrile-butadiene rubber (NBR), chloroprene rubber (CR), silicone rubber and urethane rubber, the contact width W is normally set to 0.1 to 2.2 mm.

On the side opposite to the latent-image supporting member 2 with respect to the intermediate transfer member 3, normally, primary transfer rollers 4 (4a, 4b, 4c, and 4d) are placed. As shown in FIG. 4, the primary transfer rollers 4 are normally placed on the downstream side of the intermediate transfer member 21 in its moving direction from the contact portion 8 so that they are allowed to press the intermediate transfer member 3 so as to maintain a predetermined pressing force F.

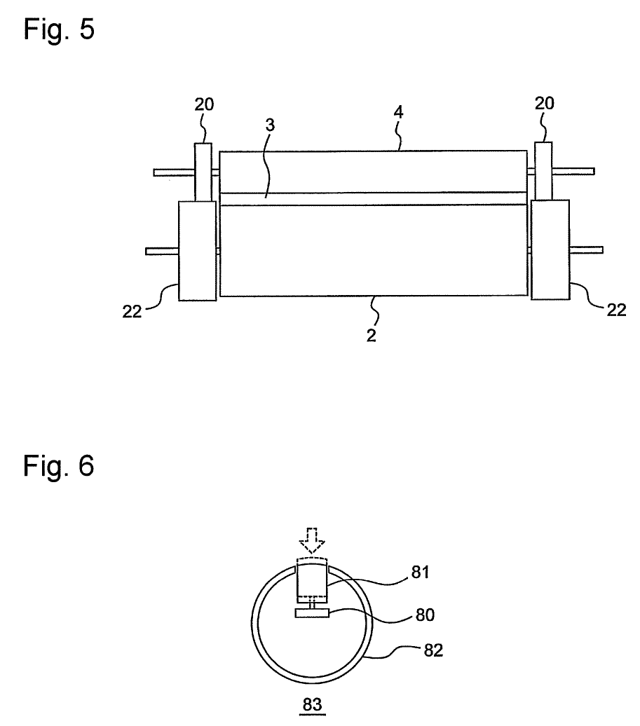

The primary transfer roller 4 is placed based upon a position fixing system (fixed position press-contacting system), and normally, as shown in FIG. 5, pitch rings 20 are installed. FIG. 5 is a schematic sketch view obtained when the latent-image supporting member 2, the intermediate transfer member 3 and the primary transfer roller 4, shown in FIG. 4, are viewed from the upstream side in the advancing direction 21 of the intermediate transfer member 3. The pitch rings 20, each having a disc shape, are placed on the two ends of the primary transfer roller 4 coaxially with the primary transfer roller 4 so that when they are pressed against the latent-image supporting member 2, the distance between the axes of the primary transfer roller 4 and the latent-image supporting member 2 is maintained at a fixed distance. Here, as shown in FIG. 5, disc-shaped fixing members 22 may be placed coaxially on the two ends of the shaft of the latent-image supporting member so that, in this case, by pressing the pitch rings 20 onto the fixing members 22, the distance between the axes of the primary transfer roller 4 and the latent-image supporting member 2 is maintained at a fixed distance. By placing the primary transfer roller based upon the position fixing system, an effective controlling process is available even when the pressing force F is comparatively low. For example, by adjusting the outer diameters of the pitch rings 20 and the fixing members 22 as well as by adjusting the installation position of the primary transfer roller in the advancing direction of the intermediate transfer member, the pressing force F can be controlled with precision comparatively. In the case when the primary transfer roller is placed based upon a constant pressure system by using a spring or the like, it is not possible to control the pressing force sufficiently within a comparatively low pressure range. It becomes difficult to positively form the transfer nip due to rattling of the primary transfer roller and the transfer belt, with the result that a defective transfer such as an image loss tends to occur. Such a defective transfer is not a defective transfer within a fine area such as a void, but a phenomenon in which the entire toner on the photosensitive member is not transferred due to a gap between the photosensitive member and the transfer belt caused by an insufficient formation of the transfer nip. In such an unstable state of the nip formation, transferable and untransferable areas are produced, and the untransferable portion causes an image loss.

More specifically, for example, when the outer diameters of the pitch ring 20 and/or the fixing member 22 are increased or when the installation position of the primary transfer roller is separated further on the downstream side in the moving direction 21 of the intermediate transfer member from the contact portion 8, the pressing force F and the contact width W are reduced.

When the outer diameters of the pitch ring 20 and/or the fixing member 22 are reduced or when the installation position of the primary transfer roller is made closer to the contact portion 8, the pressing force F and the contact width W are increased.

The primary transfer roller is preferably made of metal such as iron and aluminum or a rigid material such as a hard resin. Thus, the pressing force F can be pressure-distributed uniformly over the entire area in the axial direction of the primary transfer roller within a predetermined low pressure area.

With respect to the extension rollers (10, 11), not particularly limited, for example, metal rollers, made of aluminum or iron, may be used. A roller having a structure in which a coating layer is formed on the peripheral face of a core metal member, with the coating layer being made by dispersing conductive powder or carbon in an elastic material such as EPDM, NBR, urethane rubber and silicone rubber, may be used, and the resistivity of this roller is adjusted to 1×10⁹ Ω·cm or less.

The other members and devices installed in the image-forming apparatus of the present invention, that is, for example, a secondary transfer roller 5, a belt cleaning device 7, a charging device, an exposing device, a developing device and a cleaning device for the latent-image supporting member are not particularly limited, and those known members and devices conventionally used in the image-forming apparatus can be used.

For example, with respect to the developing device, those having a mono-component developing system using only toner, or those having a two-component developing system using toner and carrier, may be used.

The toner may contain toner particles manufactured by a wet method such as a polymerization method or toner particles manufactured by a pulverizing method (dry method).

Not particularly limited, the average particle size of the toner is set to 7 μm or less, in particular, in the range from 4.5 μm to 6.5 μm. As the toner average particle size becomes smaller, the secondary transferring rate becomes worse, and the possibility of occurrence of a void becomes higher at the time of a primary transferring process; however, the present invention makes it possible to effectively prevent the above-mentioned problem even when such a particle size is used.

### EXAMPLES

### Experimental Example 1

### (Production of Transfer Belt A (Non-Elastic))

A substrate having a seamless shape, which was made from a PPS resin having carbon dispersed therein and had a surface resistivity in the range from 1×10⁹ Ω/square to 1×10¹⁰ Ω/square, a volume resistivity in the range from 1×10⁸ Ω·cm to 1×10⁹ Ω·cm and a thickness of 0.15 mm, was obtained by using an extrusion-molding process.

The outer circumferential surface of the substrate was coated with a SiO₂ thin film (hardness: 4.5 GPa) having a film thickness of 200 nm by using an atmospheric pressure plasma CVD method so that a transfer belt A was obtained.

### (Evaluation)

The transfer belt A was attached to a Bizhub C350 (made by Konica Minolta Technologies, Inc.) having a structure shown in FIG. 1. More specifically, the outer diameter of the photosensitive member was 30 mm, the outer diameter of the primary transfer roller was 12 mm, and the center of the primary transfer roller shaft was maintained in a press-contact state to the transfer belt as a home position by the pitch rings at 4 mm on the downstream side in the transfer belt advancing direction with respect to the center of the photosensitive member shaft. Here, the primary transfer roller which was made of iron (SUM 22) was used.

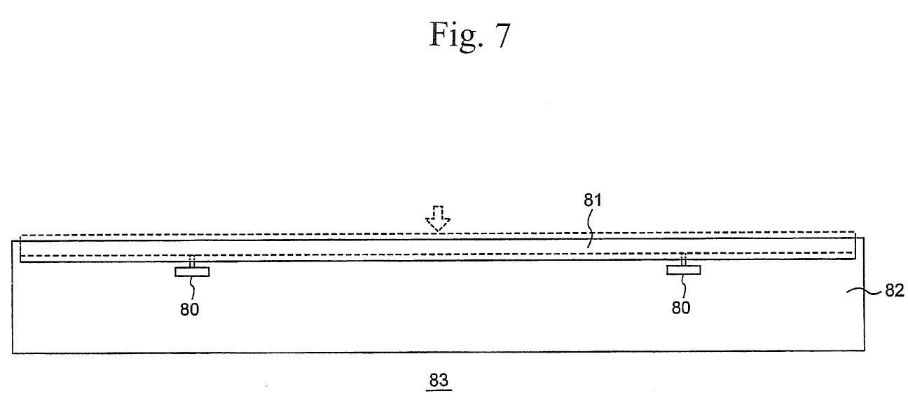

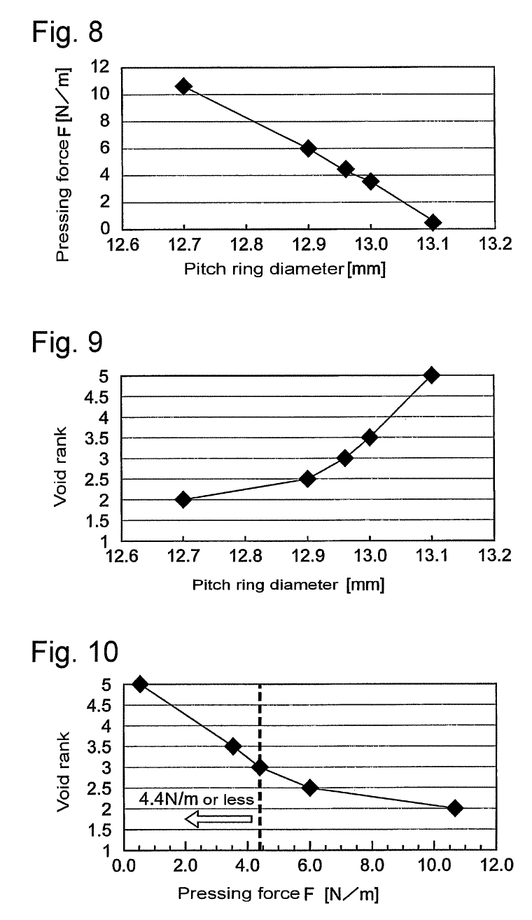

With the outer diameter of each of the pitch rings attached to the two ends of the primary transfer roller shaft being varied from 12.7 mm to 13.1 mm, the pressing force F exerted between the photosensitive member and the transfer belt in the primary transferring unit was measured, and the results shown in FIG. 8 were obtained. At this time, a line image portion in a red color formed by superposing two colors of cyan and magenta was printed, and the image was sensory-evaluated visually for any void. FIG. 9 shows the results of the evaluation. The evaluation was carried out based upon void ranks of 9 stages with rank 1 (bad) to rank 5 (best).

Based upon the results of these experiments, the relationship between the pressing force F and the void-preventive property in the primary transferring unit was found, and the results are shown in FIG. 10. Since the permissible level of the void-preventive property is rank 3 or more, it is clearly indicated that the permissible range of the pressing force F in the primary transferring unit is 4.4 [N/m] or less. In order to improve the void-preventive property, it is preferable to reduce the pressing force F between the photosensitive member and the transfer belt in the primary transferring unit so as to restrain toner aggregation in the primary transferring unit as shown by the present Examples.

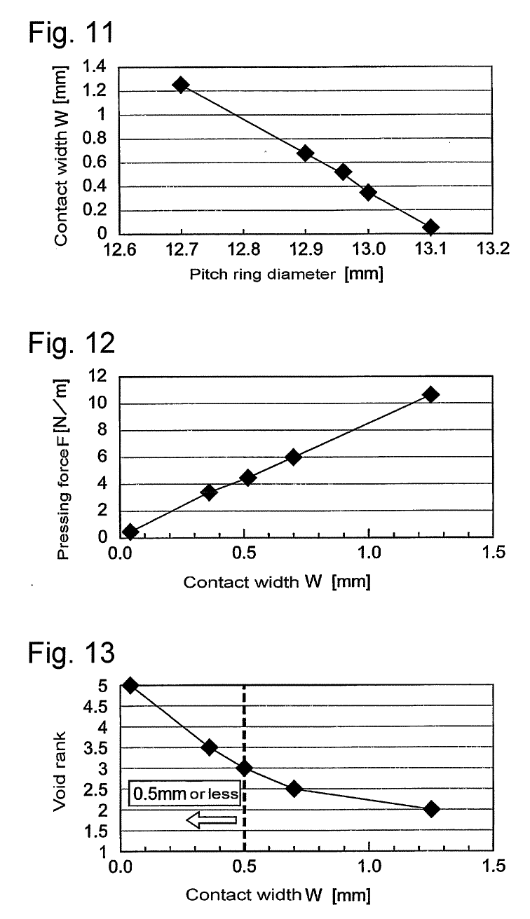

With the outer diameter of each of the pitch rings being varied from 12.7 mm to 13.1 mm, the contact width (nip width) W between the photosensitive member and the transfer belt in the primary transferring unit was measured, and the results shown in FIG. 11 were obtained.

The relationship between the contact width W and the pressing force F in the primary transferring unit is shown in FIG. 12.

The relationship between the contact width W in the primary transferring unit and the void-preventive property is shown in FIG. 13. The contact width W in the primary transferring unit that would provide the void rank of 3 or more was 0.5 [mm] or less. As clearly indicated by these, in the intermediate transfer belt using a non-elastic substrate, the contact width W of the primary transferring unit is preferably set to 0.5 mm or less.

After a solid image of each color (amount of toner adhesion on the transfer belt: 4.40 g/cm²) had been secondary-transferred under each of primary transferring conditions of the respective Examples, the residual toner after the transferring process, left on the transfer belt, was measured and found to be 0.08 g/m². The secondary transferring rate was about 98.2%, which was a good value.

### Experimental Example 2

### (Production of Transfer Belt B (Elastic))

A substrate having a seamless shape, which was made from an urethane resin having carbon dispersed therein and had a surface resistivity of 1×10¹⁰Ω/square, a volume resistivity of 1×10⁸ Ω·cm and a thickness of 0.15 mm, was obtained by using an extrusion-molding process.

The peripheral face of the substrate was coated with a SiO₂ thin film (hardness: 4.5 GPa) having a film thickness of 200 nm by using an atmospheric pressure plasma CVD method so that a transfer belt B was obtained.

### (Evaluation)

Evaluating processes were carried out by using the same evaluation method as that of Experimental Example 1 except that the transfer belt B was used with the outer diameter of each of the pitch rings attached to the two ends of the primary transfer roller shaft being varied from 11.8 mm to 13.1 mm.

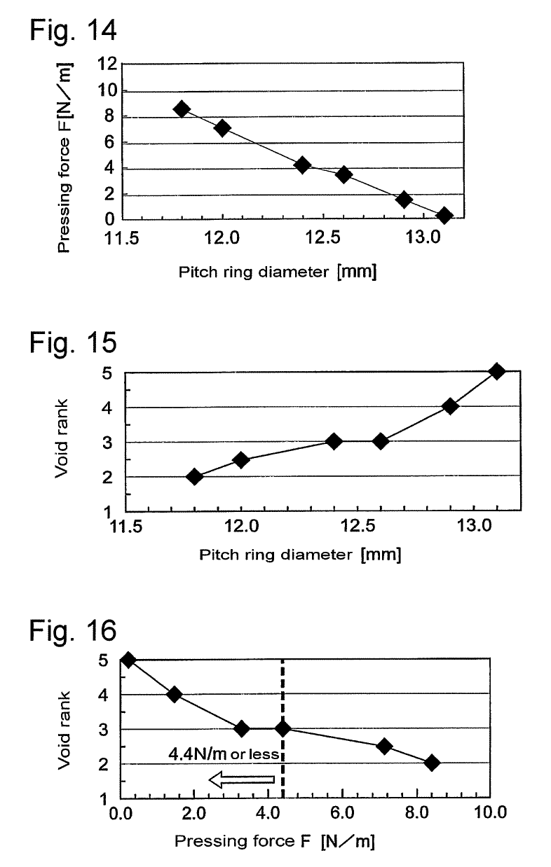

The relationship between the outer diameter of the pitch ring and the pressing force F exerted between the photosensitive member and the transfer belt in the primary transferring unit was obtained as shown in FIG. 14. At this time, a line image portion was printed, and the image was sensory-evaluated visually for any void. FIG. 15 shows the results of the evaluation.

Based upon the results of these experiments, the relationship between the pressing force F and the void-preventive property in the primary transferring unit was found, and the results shown in FIG. 16 were obtained. Since the permissible level of the void-preventive property is rank 3 or more, it is clearly indicated that the permissible range of the pressing force F in the primary transferring unit is 4.4 [N/m] or less.

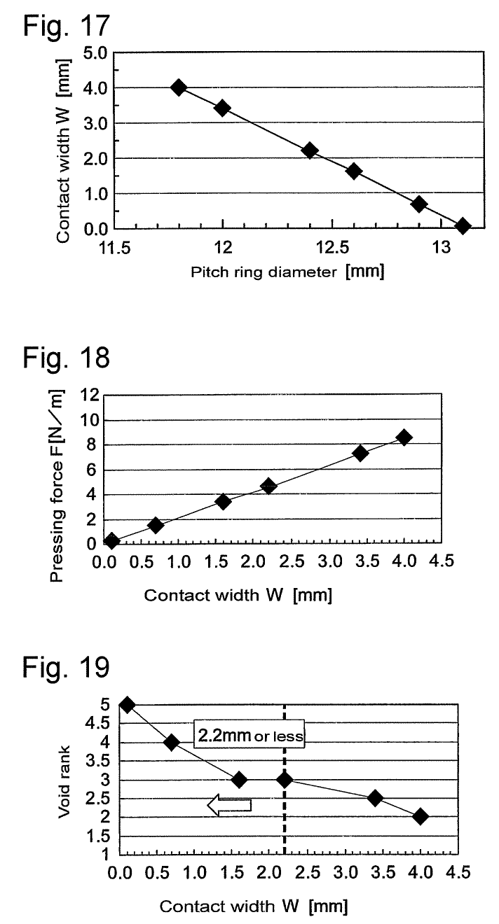

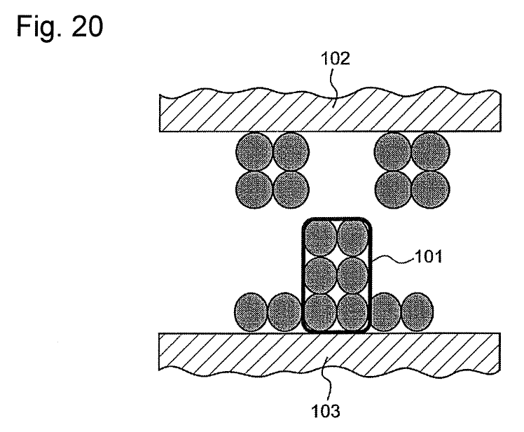

The contact width (nip width) W between the photosensitive member and the transfer belt in the primary transferring unit was measured with the outer diameter of each of the pitch rings being varied within the above-mentioned range, and the results shown in FIG. 17 were obtained.

The relationship between the contact width W and the pressing force F in the primary transferring unit is shown in FIG. 18.

The relationship between the contact width W and the void-preventive property is shown in FIG. 19. The contact width W in the primary transferring unit that provides the void rank of 3 or more is 2.2 [mm] or less. As clearly indicated by these, in the intermediate transfer belt using an elastic substrate, the contact width W of the primary transferring unit is preferably set to 2.2 mm or less.

After a solid image of each color (amount of toner adhesion on the transfer belt: 4.40 g/cm²) had been secondary-transferred under each of primary transferring conditions of the respective examples, the residual toner after the transferring process, left on the transfer belt, was measured and found to be 0.08 g/m². The secondary transferring rate was about 98.2%, which was a good value.

What is claimed is:

1. An image-forming apparatus, comprising:
a latent-image supporting member, and
an intermediate transfer member having a hard releasing layer formed on the surface of the intermediate transfer member that supports a toner image primarily transferred thereon from the latent-image supporting member, and secondarily transfers the supported toner image onto an image receiving medium,
wherein a pressing force F, exerted at a contact portion between the intermediate transfer member and the latent-image supporting member, is set to 4.4 N/m or less.

2. The image-forming apparatus according to claim 1, wherein the hard releasing layer is an inorganic oxide layer.

3. The image-forming apparatus according to claim 1, wherein the hard releasing layer is a hard-carbon containing layer.

4. The image-forming apparatus according to claim 1, wherein the intermediate transfer member is formed into a seamless belt shape.

5. The image-forming apparatus according to claim 4, wherein the contact portion between the intermediate transfer member and the latent-image supporting member has a contact width W of 2.2 mm or less in a moving direction of the intermediate transfer member.

6. The image-forming apparatus according to claim 1, further comprising: a primary transfer roller made of metal, which is placed on the downstream side in the moving direction of the intermediate transfer member from the contact portion between the intermediate transfer member and the latent-image supporting member.

7. The image-forming apparatus according to claim 1, wherein the pressing force F is set to 0.05 to 4.4 N/m.

8. The image-forming apparatus according to claim 1, wherein the pressing force F is set to 0.05 to 2.0 N/m.

9. The image-forming apparatus according to claim 2, wherein a thickness of the inorganic oxide layer is in the range from 10 to 100 nm.

10. The image-forming apparatus according to claim 2, wherein the inorganic oxide layer comprises SiO₂.

11. The image-forming apparatus according to claim 5, wherein the contact width W is set in the range from 0.01 to 2.2 mm.
